(19) United States
(12) Patent Application Publication
(10) Pub. No.: US 2026/0317962 A1
(43) Pub. Date: Oct. 15, 2026

(54) WASTE TEXTILE OPENING MACHINE

(71) Applicant: QINGDAO HONGDA TEXTILE MACHINERY CO., LTD., Qingdao (CN)

(72) Inventors: Jingda NI, Qingdao (CN); Huachun ZHAN, Qingdao (CN); Zhongtao LI, Qingdao (CN); Zhonghao CUI, Qingdao (CN); Yong WANG, Qingdao (CN); Tao GE, Qingdao (CN)

(21) Appl. No.: 19/551,081

(22) Filed: Feb. 26, 2026

Related U.S. Application Data
(63) Continuation of application No. PCT/CN2024/104659, filed on Jul. 10, 2024.

(30) Foreign Application Priority Data
Apr. 2, 2024 (CN) 202410394014.X

(51) Int. Cl. D01G 11/04

(52) U.S. Cl. CPC D01G 11/04

(57) ABSTRACT

A waste textile opening machine includes a housing, a cotton feeding plate, a cotton feeding roller, an opening beater and an adjustable arc-shaped bar grid, and further including a fiber cloth separation device. The fiber cloth separation device includes a negative-pressure fan, a conveying channel, a speed reduction channel and an airflow cutting plate. One end of the conveying channel communicates with an opening beater channel below the opening beater, and the other end of the conveying channel communicates with the speed reduction channel. An outlet of the speed reduction channel communicates with an upward fiber outlet and a downward cloth outlet. An air supplementing mesh plate is on the bottom surface of the speed reduction channel, the airflow cutting plate in the middle in the speed reduction channel divides the interior into an upper-layer channel and a lower-layer channel, and the negative-pressure fan communicates with the fiber outlet.

### TECHNICAL FIELD

The present invention belongs to the technical field of textile machinery manufacturing, relates to improvements in opening machines, and specifically concerns a waste textile opening machine.

### BACKGROUND

Opening machines are primarily designed to process materials such as fibers, cotton, and textiles by tearing large fabric pieces into smaller tufts or bundles while simultaneously achieving separation.

In the processing of waste textiles, particularly discarded garments and fabric scraps, multiple opening machines are typically arranged in series to achieve the desired opening effect. However, the resulting semi-finished products often fail to meet the requirements of downstream processes. Specifically, small fabric blocks remain mixed with regenerated fibers, necessitating repeated opening cycles. This redundant processing not only degrades the mechanical properties and shortens the length of the regenerated fibers but also reduces production efficiency and increases operational costs. Furthermore, manual sorting of these fabric blocks is labor-intensive, inefficient, and presents significant challenges for quality control.

A prior art device, which is disclosed in a Chinese Patent (CN 202221314106.5, titled “Fiber Separation Device for Regenerated Textile Fabrics,”), utilizes a sliding board to separate fabric scraps from fibers. This device operates by decelerating the raw materials as they pass through the sliding board and leveraging the differences in specific gravity between fibers and fabric scraps. Negative pressure is then applied to separate the two components to facilitate subsequent combing and spinning. While this approach mitigates repeated opening and fiber damage to some extent, several technical challenges remain:

The separation device operates as a standalone unit and must be used in conjunction with existing opening machines. The inability to organically integrate the device with the opening machine prevents structural simplification and fails to reduce overall equipment costs. 2. The levels of automation and production efficiency are insufficient to meet the demands of modern industrial-scale production. 3. The device cannot automatically adjust its operating parameters based on varying fiber contents or material compositions, which limits its effectiveness in achieving thorough separation of fibers from fabric blocks.

Therefore, there is a critical need in the field for an innovative waste textile opening machine that enables more thorough separation, allows regenerated fibers to proceed directly to subsequent processes while collecting fabric blocks for re-opening, improves automation and efficiency, and reduces the manufacturing footprint and costs.

### SUMMARY

To address the problems and deficiencies in the existing technology, the present invention provides a waste textile opening machine. By replacing the conventional output structure of an opening machine with a fiber-cloth fragment separating unit, the invention achieves a more thorough separation of fibers and cloth fragments through negative pressure suction. The regenerated fibers can directly proceed to the subsequent process, while the cloth fragments are collected for repeated opening. This configuration improves the degree of automation and production efficiency, while simultaneously reducing the overall manufacturing cost and the footprint of the equipment.

The objectives of this invention are accomplished through the following technical solution:

A waste textile opening machine, comprising: a machine housing; a feeding board; feeding rollers; an opening beater; and an adjustable curved grid bar; wherein the waste textile opening machine further comprises a fiber-cloth fragment separating device, the fiber-cloth fragment separating device comprising a negative pressure fan, a conveying channel, a deceleration channel, and an airflow cutting plate; wherein the conveying channel is horizontally disposed within the machine housing; wherein one end of the conveying channel is in fluid communication with an opening beater channel positioned below the opening beater, and the other end of the conveying channel is in fluid communication with an inlet of the deceleration channel; wherein an outlet of the deceleration channel is in fluid communication with an upward fiber outlet and a downward cloth fragment outlet; wherein an air-supplementing mesh plate is disposed on a bottom surface of the deceleration channel; wherein the airflow cutting plate is disposed at a middle position within the deceleration channel to divide an interior of the deceleration channel into an upper channel and a lower channel; and wherein the negative pressure fan is in fluid communication with the fiber outlet and is configured to generate an airflow for conveying recycled fibers.

As an improvement of the present invention, a cross-section of the deceleration channel gradually increases from the inlet end to the outlet end; wherein a top surface of the airflow cutting plate is a flat surface, a bottom surface of the airflow cutting plate is a smooth convex surface, and both ends of the airflow cutting plate are pointed tips; and wherein the top surface of the airflow cutting plate is inclined such that an end proximate to the fiber outlet is a high end.

As an improvement of the present invention, the airflow cutting plate is equipped with a controller, an image sensor, an electric push rod, and rotating shafts; wherein the image sensor and the electric push rod are respectively connected to the controller; wherein the rotating shafts are respectively disposed on two side surfaces of the deceleration channel and are respectively connected to two sides of the airflow cutting plate; wherein the electric push rod is disposed outside the deceleration channel, and a moving end of the electric push rod is connected to at least one of the rotating shafts to drive the airflow cutting plate to rotate around the rotating shafts; wherein the image sensor is configured to detect a proportion of cloth fragments in the recycled fibers within the fiber outlet; and wherein the controller is configured to automatically control the electric push rod to adjust an inclination angle of the top surface of the airflow cutting plate in real-time based on the proportion detected by the image sensor.

As an improvement of the present invention, the outlet end of the deceleration channel extends out of the machine housing; the outlet of the deceleration channel is connected to a vertically disposed square discharge pipe; and the fiber outlet and the cloth fragment outlet are an upper port and a lower port of the square discharge pipe, respectively.

As an improvement of the present invention, a top surface and a bottom surface of the conveying channel are both trapezoidal and are disposed parallel to each other; and wherein an end of the conveying channel connected to the deceleration channel has a minimum width. As an improvement of the present invention, a top surface of the deceleration channel is an inclined surface, and an end of the top surface connected to the conveying channel is a lowest end; and wherein the bottom surface of the deceleration channel and the bottom surface of the conveying channel are an integrated structure and are positioned on a same horizontal plane.

Compared with the prior art, the advantages and positive effects of the present invention are as follows:
1) By replacing the conventional output structure with the fiber-cloth fragment separating unit, the materials undergo beater opening before reaching the separating device, ensuring that fibers and cloth fragments are disentangled for superior separation. The use of negative pressure suction for separation prevents secondary damage to the regenerated fibers. The regenerated fibers proceed directly to subsequent processes, while cloth fragments are collected for re-opening, resulting in high production efficiency and automation without the need for manual intervention.
2) The introduction of supplemental airflow through the air-supplementing mesh plate at the bottom of the deceleration channel facilitates the separation of fibers and cloth fragments, making the separation effect more pronounced.
3) The fiber-cloth fragment separating device is integrated with the opening machine, simplifying the overall structure. This eliminates the need for additional production line equipment, thereby reducing manufacturing costs and the equipment footprint.
4) The opening machine of the present invention offers flexible placement; it can be deployed either as the final unit in an opening machine group or integrated within the middle of the group.
5) The system can automatically adjust the inclination angle of the airflow cutting plate based on the specific composition of cloth fragments within the regenerated fibers, achieving a more thorough separation.
6) The conveying channel and the deceleration channel are connected in fluid communication to form a fully enclosed structure, ensuring a clean and tidy production environment.

### DESCRIPTION OF THE DRAWINGS

FIG. 1 is a schematic structural view of a waste textile opening machine according to the present invention;

FIG. 2 is a perspective view of a conveying channel and a deceleration channel in the waste textile opening machine according to the present invention; and

FIG. 3 is a schematic view of an internal structure of the conveying channel and the deceleration channel in the waste textile opening machine according to the present invention.

### REFERENCE NUMERALS

1. Feeding board; 2. Feeding rollers; 3. Safety cover plate; 4.Adjustable curved grid bar; 5. Opening beater; 6. Conveying channel; 7. Airflow cutting plate; 8. Rotating shafts; 9. Fiber outlet; 10. Image sensor; 11. Square discharge pipe; 12. Cloth fragment outlet; 13. Air-supplementing mesh plate; 14. Deceleration channel; 15. Electric push rod.

### DETAILED DESCRIPTION

The present invention is further described in detail below with reference to the accompanying drawings.

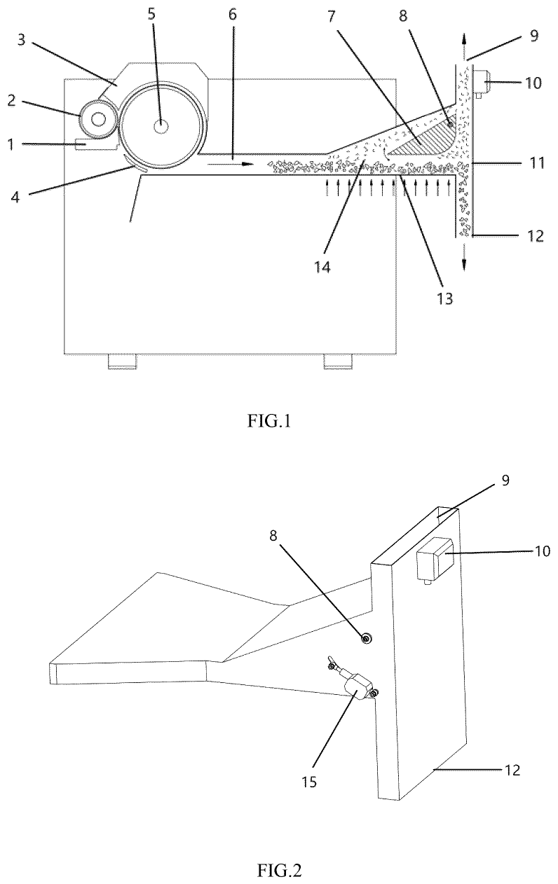

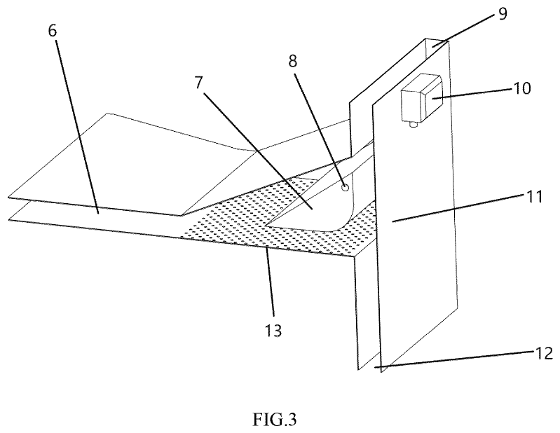

Referring to FIGS. 1-3, an embodiment of a waste textile opening machine according to the present invention includes a machine housing, a feeding board 1, feeding rollers 2, an opening beater 5, and an adjustable curved grid bar 4. The waste textile opening machine further includes a fiber-cloth fragment separating device. A safety cover plate 3 is disposed above the opening beater 5. The fiber-cloth fragment separating device includes a negative pressure fan, a conveying channel 6, a deceleration channel 14, and an airflow cutting plate 7. The conveying channel 6 is horizontally disposed within the machine housing. One end of the conveying channel 6 is in fluid communication with an opening beater channel positioned below the opening beater 5, and the other end of the conveying channel 6 is in fluid communication with an inlet of the deceleration channel 14. An outlet of the deceleration channel 14 is in fluid communication with an upward fiber outlet 9 and a downward cloth fragment outlet 12. An air-supplementing mesh plate 13 is disposed on a bottom surface of the deceleration channel 14. The airflow cutting plate 7, which is disposed at a middle position within the deceleration channel 14, divides an interior of the deceleration channel 14 into an upper channel and a lower channel. A negative pressure fan (not shown) is in fluid communication with the fiber outlet 9 and is configured to generate an airflow for conveying recycled fibers. A cloth fragment collection port is connected to a material return device.

Further, a cross-section of the deceleration channel 14 gradually increases from the inlet end to the outlet end. A top surface of the airflow cutting plate 7 is a flat surface, and a bottom surface thereof is a smooth convex surface. Both ends of the airflow cutting plate 7 are pointed tips. The top surface of the airflow cutting plate 7 is inclined such that an end proximate to the fiber outlet 9 is a high end.

Specifically, the airflow cutting plate 7 is equipped with a controller, an image sensor 10, an electric push rod 15, and rotating shafts 8. The image sensor 10 and the electric push rod 15 are respectively connected to the controller. The rotating shafts 8 are respectively disposed on two side surfaces of the deceleration channel 14 and are respectively connected to two sides of the airflow cutting plate 7. The electric push rod 15 is disposed outside the deceleration channel 14, and a moving end of the electric push rod 15 is connected to the rotating shafts 8 to drive the airflow cutting plate 7 to rotate around the rotating shafts 8. The image sensor 10 is configured to detect a proportion of cloth fragments in the recycled fibers within the fiber outlet 9. The controller automatically controls the electric push rod 15 to adjust an inclination angle of the top surface of the airflow cutting plate 7 in real-time based on the proportion of cloth fragments in the recycled fibers detected by the image sensor 10.

Still further, the outlet end of the deceleration channel 14 extends out of the machine housing. The outlet of the deceleration channel 14 is connected to a vertically disposed square discharge pipe 11. The fiber outlet 9 and the cloth fragment outlet 12 are an upper port and a lower port of the square discharge pipe 11, respectively.

Yet further, a top surface and a bottom surface of the conveying channel 6 are both trapezoidal and are disposed parallel to each other. An end of the conveying channel 6 connected to the deceleration channel 14 has a minimum width.

Even further, a top surface of the deceleration channel 14 is an inclined surface, and an end of the top surface connected to the conveying channel 6 is a lowest end. The bottom surface of the deceleration channel 14 and the bottom surface of the conveying channel 6 are an integrated structure and are positioned on a same horizontal plane.

The working principle of the present invention is: the raw materials or semi-finished products of waste textiles enter an opening zone via the feeding board 1 and the feeding rollers 2. After being opened by the opening beater 5 and having impurities removed by the adjustable curved grid bar 4, the materials enter the fiber-cloth fragment separating device through a discharge port. Since the cross-section of the inlet of the fiber-cloth fragment separating device gradually expands, the raw materials and the airflow decelerate and diffuse within the deceleration channel 14. Under the influence of the supplemental airflow introduced through the air-supplementing mesh plate 13, the raw materials rapidly stratify: lightweight recycled fibers occupy the upper channel, while heavier cloth fragments are distributed in the upper and lower channels. As the airflow cutting plate 7 cuts the airflow, the recycled fibers enter the fiber outlet 9 via the upper channel, and the cloth fragments enter the square discharge pipe 11 via the lower channel and strike a vertical inner wall of the square discharge pipe 11. After the collision, the velocity of the raw materials decreases again. Due to the differences in weight and morphological characteristics between the recycled fibers and the cloth fragments, a secondary separation occurs: the recycled fibers enter the fiber outlet 9 under negative pressure, while the cloth fragments fall into the cloth fragment outlet 12.

In a specific embodiment, the image sensor 10 automatically detects a content of cloth fragments within the fiber outlet 9 and compares the detected value with a preset value. Based on the comparison result, the electric push rod 15 is actuated to drive the airflow cutting plate 7 to swing around the rotating shafts 8, thereby adjusting an opening angle between the top surface of the airflow cutting plate 7 and the air-supplementing mesh plate 13 to achieve a more thorough separation of fibers and cloth fragments.

It should be understood that the above descriptions are not intended to limit the present invention, and the present invention is not limited to the above-mentioned examples. Any variations, modifications, additions, or substitutions made by those of ordinary skill in the art within the substantial scope of the present invention shall also fall within the scope of protection of the present invention.

1. A waste textile opening machine, comprising:
a machine housing;
a feeding board;
feeding rollers;
an opening beater;
and an adjustable curved grid bar;
wherein the waste textile opening machine further comprises a fiber-cloth fragment separating device, the fiber-cloth fragment separating device comprising a negative pressure fan, a conveying channel, a deceleration channel, and an airflow cutting plate; wherein the conveying channel is horizontally disposed within the machine housing; wherein one end of the conveying channel is in fluid communication with an opening beater channel positioned below the opening beater, and the other end of the conveying channel is in fluid communication with an inlet of the deceleration channel; wherein an outlet of the deceleration channel is in fluid communication with an upward fiber outlet and a downward cloth fragment outlet; wherein an air-supplementing mesh plate is disposed on a bottom surface of the deceleration channel; wherein the airflow cutting plate is disposed at a middle position within the deceleration channel to divide an interior of the deceleration channel into an upper channel and a lower channel; and wherein the negative pressure fan is in fluid communication with the fiber outlet and is configured to generate an airflow for conveying recycled fibers.

2. The waste textile opening machine of claim 1, wherein a cross-section of the deceleration channel gradually increases from the inlet end to the outlet end; wherein a top surface of the airflow cutting plate is a flat surface, a bottom surface of the airflow cutting plate is a smooth convex surface, and both ends of the airflow cutting plate are pointed tips; and wherein the top surface of the airflow cutting plate is inclined such that an end proximate to the fiber outlet is a high end.

3. The waste textile opening machine of claim 1, wherein the airflow cutting plate is equipped with a controller, an image sensor, an electric push rod, and rotating shafts; wherein the image sensor and the electric push rod are respectively connected to the controller; wherein the rotating shafts are respectively disposed on two side surfaces of the deceleration channel and are respectively connected to two sides of the airflow cutting plate; wherein the electric push rod is disposed outside the deceleration channel, and a moving end of the electric push rod is connected to at least one of the rotating shafts to drive the airflow cutting plate to rotate around the rotating shafts; wherein the image sensor is configured to detect a proportion of cloth fragments in the recycled fibers within the fiber outlet; and wherein the controller is configured to automatically control the electric push rod to adjust an inclination angle of the top surface of the airflow cutting plate in real-time based on the proportion detected by the image sensor.

4. The waste textile opening machine of claim 1, wherein the outlet end of the deceleration channel extends out of the machine housing; the outlet of the deceleration channel is connected to a vertically disposed square discharge pipe; and the fiber outlet and the cloth fragment outlet are an upper port and a lower port of the square discharge pipe, respectively.

5. The waste textile opening machine of claim 3, wherein the outlet end of the deceleration channel extends out of the machine housing; the outlet of the deceleration channel is connected to a vertically disposed square discharge pipe; and the fiber outlet and the cloth fragment outlet are an upper port and a lower port of the square discharge pipe, respectively.

6. The waste textile opening machine of claim 1, wherein a top surface and a bottom surface of the conveying channel are both trapezoidal and are disposed parallel to each other; and wherein an end of the conveying channel connected to the deceleration channel has a minimum width.

7. The waste textile opening machine of claim 3, wherein a top surface and a bottom surface of the conveying channel are both trapezoidal and are disposed parallel to each other; and wherein an end of the conveying channel connected to the deceleration channel has a minimum width.

8. The waste textile opening machine of claim 5, wherein a top surface and a bottom surface of the conveying channel are both trapezoidal and are disposed parallel to each other; and wherein an end of the conveying channel connected to the deceleration channel has a minimum width.

9. The waste textile opening machine of claim 1, wherein a top surface of the deceleration channel is an inclined surface, and an end of the top surface connected to the conveying channel is a lowest end; and wherein the bottom surface of the deceleration channel and the bottom surface of the conveying channel are an integrated structure and are positioned on a same horizontal plane.

10. The waste textile opening machine of claim 8, wherein a top surface of the deceleration channel is an inclined surface, and an end of the top surface connected to the conveying channel is a lowest end; and wherein the bottom surface of the deceleration channel and the bottom surface of the conveying channel are an integrated structure and are positioned on a same horizontal plane.
